(19) United States
(12) Patent Application Publication
(10) Pub. No.: US 2013/0101920 A1
(43) Pub. Date: Apr. 25, 2013

(54) CATALYST, ELECTRODE, FUEL CELL, GAS DETOXIFICATION APPARATUS, AND METHODS FOR PRODUCING CATALYST AND ELECTRODE

(71) Applicants: Chihiro Hiraiwa, Osaka-shi (JP); Masatoshi Majima, Itami-shi (JP); Tetsuya Kuwabara, Osaka-shi (JP); Tomoyuki Awazu, Itami-shi (JP); Toshio Ueda, Itami-shi (JP); Toshiyuki Kuramoto, Itami-shi (JP)

(72) Inventors: Chihiro Hiraiwa, Osaka-shi (JP); Masatoshi Majima, Itami-shi (JP); Tetsuya Kuwabara, Osaka-shi (JP); Tomoyuki Awazu, Itami-shi (JP); Toshio Ueda, Itami-shi (JP); Toshiyuki Kuramoto, Itami-shi (JP)

(73) Assignee: SUMITOMO ELECTRIC INDUSTRIES, LTD., Osaka-shi, Osaka (JP)

(21) Appl. No.: 13/807,394

(22) PCT Filed: Jun. 27, 2012
(86) PCT No.: PCT/JP2011/064647

§ 371 Date: Dec. 28, 2012

(30) Foreign Application Priority Data
Jul. 1, 2010 (JP) 2010-151382

(51) Int. Cl. B01J 23/888; B01J 23/86; H01M 8/10; B01J 23/755

(52) U.S. Cl. CPC B01J 23/888; B01J 23/755; B01J 23/866; H01M 8/10
USPC 429/482; 502/315; 502/331; 502/337; 204/293; 427/115

(57) ABSTRACT

Provided are a catalyst, an electrode, a fuel cell, a gas detoxification apparatus, and the like that can promote a general electrochemical reaction causing gas decomposition or the like. A catalyst according to the present invention is used for promoting an electrochemical reaction and is chain particles 3 formed of an alloy particles containing nickel (Ni) and at least one selected from the group consisting of iron (Fe), cobalt (Co), chromium (Cr), tungsten (W), and copper (Cu).

### TECHNICAL FIELD

The present invention relates to a catalyst, an electrode, a fuel cell, a gas detoxification apparatus, and methods for producing a catalyst and an electrode; in particular, to, for example, a catalyst, an electrode, a fuel cell, and a gas detoxification apparatus that can promote decomposition of a gas or the like, and methods for producing a catalyst and an electrode.

### BACKGROUND ART

Although ammonia is an essential compound in agriculture and industry, it is hazardous to humans and hence a large number of methods for decomposing ammonia in water and the air have been disclosed. For example, a method for removing ammonia through decomposition from water containing ammonia at a high concentration has been proposed: aqueous ammonia being sprayed is brought into contact with airflow to separate ammonia into the air and the ammonia is brought into contact with a hypobromous acid solution or sulfuric acid (Patent Literature 1). Another method has also been disclosed: ammonia is separated into the air by the same process as above and the ammonia is incinerated with a catalyst (Patent Literature 2). Another method has also been proposed: ammonia-containing wastewater is decomposed with a catalyst into nitrogen and water (Patent Literature 3).

In general, waste gas from semiconductor fabrication equipment contains ammonia, hydrogen, and the like. To completely remove the odor of ammonia, the amount of ammonia needs to be reduced to the ppm order. For this purpose, a method has been commonly used in which waste gas to be released from semiconductor fabrication equipment is passed through scrubbers so that water containing chemicals absorbs the hazardous gas. On the other hand, to achieve a low running cost without supply of energy, chemicals, or the like, a treatment for waste gas from semiconductor fabrication equipment has been proposed: ammonia is decomposed with a phosphoric acid fuel cell (Patent Literature 4).

### CITATION LIST

### Patent Literature

PTL 1: Japanese Unexamined Patent Application Publication No. 7-31966

PTL 2: Japanese Unexamined Patent Application Publication No. 7-116650

PTL 3: Japanese Unexamined Patent Application Publication No. 11-347535

PTL 4: Japanese Unexamined Patent Application Publication No. 2003-45472

### SUMMARY OF INVENTION

### Technical Problem

As described above, ammonia can be decomposed by, for example, the method of using a chemical solution such as a neutralizing agent (PTL 1), the incineration method (PTL 2), or the method employing a thermal decomposition reaction with a catalyst (PTL 3). However, these methods have problems that they require chemicals and external energy (fuel) and also require periodic replacement of the catalyst, resulting in high running costs. In addition, such an apparatus has a large size and, for example, it may be difficult to additionally install the apparatus in existing equipment in some cases.

As for the apparatus (PTL 4) in which a phosphoric acid fuel cell is used to detoxify ammonia in waste gas from compound semiconductor fabrication, intensive efforts are not made for addressing an increase in pressure loss, an increase in electric resistance, and the like, which inhibit enhancement of the detoxification capability. When an electrochemical reaction is used to detoxify ammonia or the like, unless a novel structure is used to suppress, for example, an increase in pressure loss and an increase in electric resistance between electrode/collector under high-temperature environments, high treatment performance on the practical level cannot be achieved. Thus, the apparatus has still remained just an idea. Such an electrochemical reaction can be promoted and put into practical use by using a high-performance catalyst. The high-performance catalyst promotes an electrochemical reaction of decomposing ammonia or the like to increase the treatment capacity.

An object of the present invention is to provide a catalyst, an electrode, a fuel cell, and a gas detoxification apparatus that can promote a general electrochemical reaction causing gas decomposition or the like, and methods for producing a catalyst and an electrode.

### Solution to Problem

A catalyst according to the present invention is used for promoting an electrochemical reaction. This catalyst contains an alloy containing nickel (Ni) and at least one selected from the group consisting of iron (Fe), cobalt (Co), chromium (Cr), tungsten (W), and copper (Cu).

The above-described configuration promotes decomposition of a gas or the like and allows a gas detoxification apparatus, a fuel cell, and the like that have a small size and a high treatment capacity.

The catalyst may be chain particles in which particles that have a diameter of 0.5 μm or less and are formed of the alloy are connected to form an elongated shape.

In the chain particles, alloy particles are connected to one another so as to extend in the form of strings while the shape of individual particles somewhat remains. Accordingly, in the surface of the chain particles, irregularities constituted by projecting surfaces of the particles and recesses in connection portions of the particles extend in the longitudinal direction of the strings. On the surface of the alloy particles, fine protrusions are densely distributed. Thus, the projections and the protrusions are distributed at a high density on the surface of the chain particles. A catalyst according to the present invention exhibits very high catalysis at specific points having the shape of protrusions. In this case, the specific points are distributed at a very high density, compared with catalysis provided by an alloy in the form of a bulk, a plate, or the like. Accordingly, very high catalysis can be provided, compared with an alloy in the form of a bulk or a plate.

Here, the chain particles do not denote the so-called “chains” constituted by connection of metal rings, but denote a structure in which metal particles are connected to extend and form fine irregularities and densely distributed protrusions, and the irregularities and the like appear as irregularities of chains.

In the chain particles, the composition of the alloy particles containing nickel and at least one selected from the group consisting of iron (Fe), cobalt (Co), chromium (Cr), tungsten (W), and copper (Cu) may vary in the chain particles. For example, neighboring particles do not have to have the same composition: for example, the composition may periodically vary.

The chain particles may have branches and form dendritic chain particles in which the branched chain particles are intertwined.

In this case, a porous catalyst in which microscopic pores are ensured can be provided. Thus, the gas to be decomposed can be easily brought into contact with the catalyst and the treatment performance for gas decomposition can be enhanced with a relatively small membrane electrode assembly (MEA) or the like.

The alloy may contain 0.5% or less by weight of titanium (Ti).

In the present invention, a trivalent titanium (Ti) ion may be used as a reducing agent in a liquid-phase process to provide the chain particles formed of alloy particles. In this case, the nickel ion, the iron ion, and the like are reduced by the trivalent titanium and receive electrons; and the alloy particles deposit from the nickel ion, the iron ion, and the like. The trivalent titanium loses an electron and turns into a tetravalent titanium ion. Although the alloy particles deposit from the aqueous solution containing the ions and hence contain trivalent and tetravalent titanium ions, the titanium ions are present as titanium without particular distinction therebetween in the alloy particles.

Titanium contributes to enhancement of catalysis in the alloy.

The catalyst may be a woven fabric formed of fibers of the alloy or a metal-fiber woven fabric including a plated layer of the alloy. In this case, such a metal woven fabric can function as a part of a collector: the metal woven fabric is directly electrically connected to an electrode to promote the electrochemical reaction for gas decomposition in the electrode. Since the woven fabric is flexible, porous, and highly conductive, an electrical connection having a low contact resistance can be established with an electrode. Being porous is indispensable for ensuring that the gas can sufficiently come into contact with the electrode (electrode is also porous).

Among the above-described alloys having catalysis, some alloys have high oxidation resistance. When such an alloy is used for an air electrode, which is in contact with oxygen, a collector that can maintain a low electric resistance and has high durability can be provided for the air electrode.

The catalyst may be a porous plated body formed of the alloy or a porous plated body including a plated layer of the alloy. When such a porous plated body is disposed to prevent a gas from passing without being treated, a structure in which the porous plated body and an electrode are in direct contact with each other may be employed. In this case, the porous plated body can exhibit catalysis in the decomposition reaction in the electrode that is in contact with the porous plated body. An oxidation-resistant porous plated body that is in contact with the air electrode can provide the same effects as in the above-described woven fabric.

The catalyst may be particles that are formed of the alloy and have an average diameter of 100 μm or less. In this case, for example, the catalyst in the form of metal paste containing particles of the alloy can be used for aiding in establishment of electrical connection between an electrode and a collector for the electrode; while the electric resistance of the electrical connection is kept low, gas decomposition in the electrode can be promoted.

The catalyst may be present with a solid electrolyte and disposed in a form of a film of the alloy or a deposit of the alloy so as to cover a surface of the solid electrolyte. The film of the alloy or the deposit of the alloy is formed on the solid electrolyte by a molten-salt electrodeposition process. Accordingly, for example, a membrane electrode assembly (MEA) can be relatively easily formed.

The following configuration may be employed: oxygen is bonded to a surface of the alloy or the alloy is covered with an oxide layer.

In the presence of oxygen, the catalysis of the alloy is further enhanced. The content, which is the alloy portion, is a good conductor and provides a good electron conduction path in an electrochemical reaction.

An electrode according to the present invention is formed by sintering any one of the above-described catalysts and an ion-conductive ceramic. By using such a porous electrode, an electrochemical reaction apparatus that has a small size and high treatment performance in terms of, for example, gas decomposition can be formed.

In the electrode above, silver particles may be dispersed. Silver has catalysis that promotes decomposition of oxygen molecules. When the electrode is used as the air electrode of a fuel cell or a detoxification apparatus, decomposition of oxygen molecules can be promoted to cause the electrochemical reaction to smoothly proceed.

A fuel cell according to the present invention includes any one of the above-described catalysts or any one of the above-described electrodes. In this case, a fuel cell that has a small size and a high power-generation capacity can be provided.

A gas detoxification apparatus according to the present invention includes any one of the above-described catalysts or any one of the above-described electrodes. In this case, a gas detoxification apparatus that has a small size and a high gas-treatment capacity can be provided.

A method for producing a catalyst according to the present invention includes a step of preparing an aqueous solution containing a nickel ion, a titanium ion, a complex ion, and at least one type selected from the group consisting of an iron ion, a cobalt ion, a chromium ion, a tungsten ion, and a copper ion; and a step of adding an alkaline aqueous solution to the aqueous solution and stirring the solutions at room temperature to 60° C. to deposit chain particles formed of an alloy particles containing nickel (Ni), at least one selected from the group consisting of iron (Fe), cobalt (Co), chromium (Cr), tungsten (W), and copper (Cu), and a trace amount of titanium (Ti).

In this case, a high-performance catalyst can be relatively easily obtained by a liquid-phase process.

The method may include a step of subjecting the deposited chain particles to a surface oxidation treatment. In this case, catalysis can be further enhanced.

A method for producing an electrode according to the present invention includes, after any one of the above-described methods for producing a catalyst, dispersing the catalyst and a powder of an ion-conductive ceramic in a solvent having flowability, applying the solvent containing the catalyst and the ion-conductive ceramic to a solid electrolyte, and sintering the catalyst and the ion-conductive ceramic. In this case, for example, a cylindrical-body MEA, which is not easily produced, can be easily produced.

### Advantageous Effects of Invention

For example, a catalyst according to the present invention can promote a general electrochemical reaction causing gas decomposition or the like and allows a small size and a high capacity; accordingly, it is advantageous for reducing the size of a fuel cell or a gas detoxification apparatus.

### BRIEF DESCRIPTION OF DRAWINGS

FIG. 1A illustrates chain particles formed of alloy particles according to a first embodiment of the present invention, a scanning electron microscopic image of the chain particles.

FIG. 1B illustrates chain particles formed of alloy particles according to a first embodiment of the present invention, an enlarged view of a portion A in FIG. 1A.

FIG. 2 is a graph illustrating the influence of the composition of Ni—Fe alloy particles in an ammonia decomposition component including an electrode containing chain particles, on power-generation output while the composition is varied.

FIG. 3 illustrates a method for producing chain particles formed of alloy particles.

FIG. 4A illustrates a gas decomposition component according to a second embodiment of the present invention: a longitudinal sectional view of a gas decomposition component serving as an electrochemical reaction apparatus, in particular, an ammonia decomposition component.

FIG. 4B illustrates a gas decomposition component according to a second embodiment of the present invention: a sectional view taken along line IVB-IVB in FIG. 1A.

FIG. 5 illustrates the electric wiring system of the gas decomposition component in FIG. 4.

FIG. 6 is an explanatory view of a material configuration and an electrochemical reaction in an anode.

FIG. 7 is an explanatory view of a material configuration and an electrochemical reaction in a cathode.

FIG. 8 is an explanatory view of a method for producing a cylindrical MEA.

FIG. 9 illustrates a gas decomposition system according to a third embodiment of the present invention.

### DESCRIPTION OF EMBODIMENTS

### First Embodiment—Catalyst—

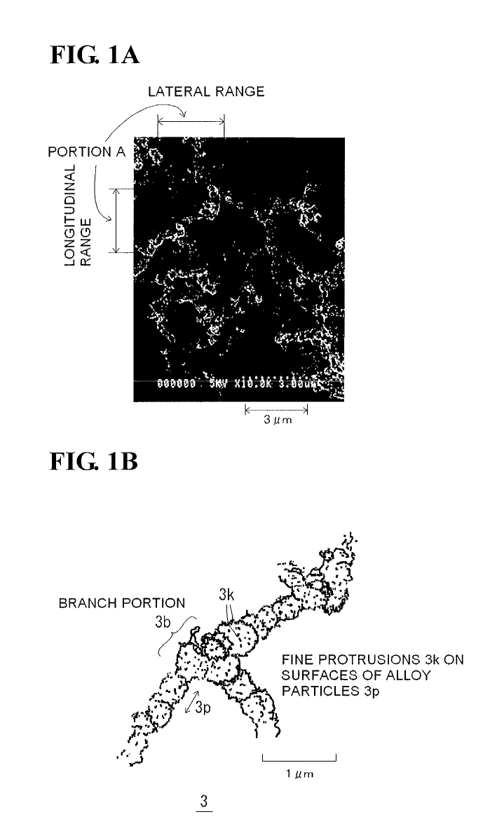

FIG. 1A illustrates a catalyst 3 according to a first embodiment of the present invention, a scanning electron microscopic image. FIG. 1B illustrates the catalyst 3 according to the first embodiment of the present invention, an enlarged view of a portion A in FIG. 1A. As illustrated in FIGS. 1A and 1B, in the catalyst 3, alloy particles 3p are connected to form chain particles. Features of the chain particles 3 in terms of shape are as follows.
(F1) From a broad view, the alloy particles 3p are connected so as to extend in the shape of elongated strings. In addition, branching occurs at a branch portion 3b and the branches are intertwined. Thus, an intertwined dendritic structure is formed.
(F2) In detail, irregularities constituted by projections of the alloy particles 3p themselves and recesses in connection portions of the alloy particles extend in the longitudinal direction of the string shape. The structure may be referred to as an irregularly shaped string.
(F3) Further, in detail, a large number of fine protrusions 3k are formed on the alloy particles 3p.

The chain particles 3 that are not treated can be used as a high-performance catalyst. Alternatively, depending on applications, the performance can be enhanced by a surface oxidation treatment; in such applications, the chain particles 3 are subjected to a surface oxidation treatment. The surface oxide layer preferably has a thickness of 1 nm to 100 nm, more preferably 10 nm to 50 nm. Depending on a gas to be decomposed, even when the surface oxidation treatment is performed and the operation is initiated, reduction is caused during the operation and the surface oxide layers may be eliminated.

In any cases, unless otherwise specified, the chain particles 3 are in any one of all the states above (the untreated state, the state where the surface oxide layers are present, and the state where the surface oxide layers have been reduced).

The composition of the alloy particles 3p will be described.

### <Ni—Fe System>

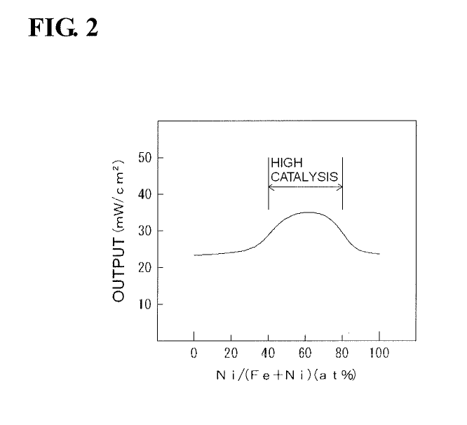

FIG. 2 is a graph illustrating results of a measurement where electrodes were formed of the chain particles 3 in which the composition of Ni—Fe alloy particles was varied, and power-generation output during decomposition of ammonia was measured. Such an electrode was an anode or a fuel electrode. In the initial stage of installation of the apparatus used for the measurement, oxide layers formed by a surface oxidation treatment were present in the chain particles 3; however, during the operation, as a result of the occurrence of the anode reaction due to introduction of a reducing gas containing ammonia, the oxide layers had been eliminated due to reduction. Note that oxidation was probably caused by oxygen ions having been generated by the cathode reaction in the air electrode and passed through the solid electrolyte.

While the material of the cathode or the air electrode, the concentration of ammonia, and the like were not changed, the composition of the chain particles 3 forming the catalyst in the anode was only varied. The concentration of ammonia was 100% by volume at the inlet and the flow rate was 50 ml/min. The ammonia decomposition apparatus used in the measurement will be described in detail in a second embodiment.

FIG. 2 indicates that, in the nickel (Ni)-iron (Fe) system, power-generation output is high and catalysis is high in the range where the Ni content is 40 at % or more and 80 at % or less. Since Fe has a higher bonding strength for oxygen than Ni, bonding of oxygen to the surface is facilitated in a Ni—Fe alloy, compared with elemental Ni. In particular, in the chain particles 3, a large number of the protrusions 3k are formed on the surfaces of the Ni—Fe alloy particles 3p and hence oxygen tends to bond to the tips of the protrusions 3k. That is, because of the feature (F3) of the chain particles, the catalysis is enhanced, compared with the effect provided by the alloy itself. Furthermore, since the feature (F2) results in an increase in the surface area of the chain particles 3, the catalysis is also enhanced in terms of the increment in the surface area, compared with the effect provided by the alloy itself. In addition, because of the feature (F1), the porosity of the porous electrode becomes high, which can also contribute to promotion of gas decomposition.

In the Ni—Fe system, the Ni content of 40 at % or more and 80 at % or less can be regarded as a composition range where the electrochemical reaction is promoted due to the above-described multiple factors.

There are other systems: Ni—Co system, Ni—Cr system, Ni—W system, and Ni—Cu system. As to these systems, as in the Ni—Fe system, the range where the catalysis is high was determined by employing such a system for the anode of the ammonia decomposition apparatus and measuring the power-generation output.

### <Ni—Co System>:

The range where the catalysis promoting decomposition of ammonia is high is widely observed over a Ni content of 20 at % or more and 80 at % or less.

### <Ni—Cr System>:

The range where the catalysis promoting decomposition of ammonia is high is observed over a Cr content of 0.25 at % or more and 50 at % or less.

### <Ni—W System>:

The range where the catalysis promoting decomposition of ammonia is high is observed over a W content of 0.25 at % or more and 50 at % or less.

### <Ni—Cu System>:

The range where the catalysis promoting decomposition of ammonia is high is observed over a Cu content of 0.25 at % or more and 50 at % or less.

All these ranges are composition ranges where the catalysis is enhanced in binary systems. A catalyst according to the present invention may be composed of an alloy of a three or more component system, though the composition range is not the same as above.

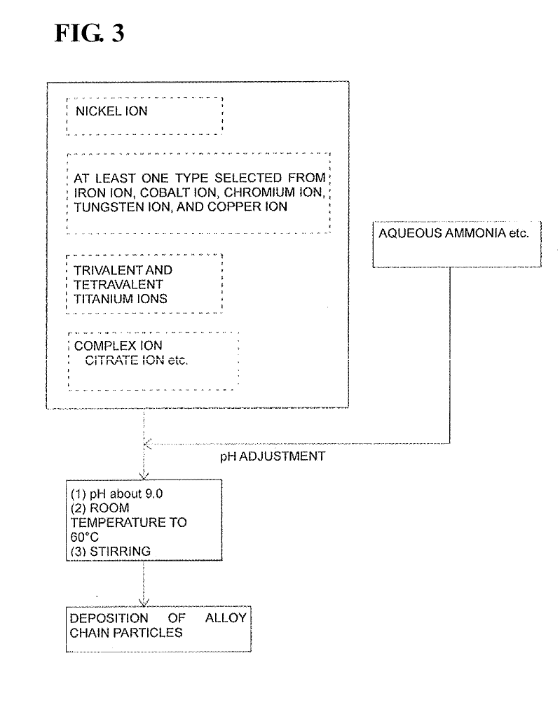

Hereinafter, a method for producing the chain particles 3 by a titanium reduction process will be described. Referring to FIG. 3, an aqueous solution is first prepared that contains a nickel ion, (trivalent and tetravalent) titanium ions, a complex ion such as a citrate ion, and at least one type selected from the group consisting of an iron ion, a cobalt ion, a chromium ion, a tungsten ion, and a copper ion, which will constitute the composition of the alloy particles. To this aqueous solution containing such metal ions, an aqueous ammonia is then added such that the pH is adjusted to be about 9.0. This solution is stirred while the solution temperature is kept at an appropriate temperature of room temperature to 60° C. At this time, the trivalent titanium (Ti) ion functions as a reducing agent; the nickel ion, the iron ion, and the like are reduced by the trivalent titanium ion and receive electrons; alloy particles deposit from the nickel ion, the iron ion, and the like. The trivalent titanium loses an electron and turns into a tetravalent titanium ion.

Although the alloy particles deposit from the aqueous solution containing the ions and hence contain trivalent and tetravalent titanium ions, the titanium ions are present as titanium without particular distinction therebetween in the alloy particles.

The mechanism by which the chain particles 3 are formed in a continuous form will be described. To form the chain particles 3, metals need to be ferromagnetic metals and also satisfy a predetermined size or more. Nickel, iron, cobalt, and the like in the state of elemental metals are ferromagnets. Chromium, tungsten, and copper contained in a nickel alloy or a nickel-iron alloy also function as ferromagnetic metals. Thus, the alloy particles serve as ferromagnets and the ferromagnetic alloy particles first attract one another through magnetic force to come into contact with one another. Subsequently, deposition and growth continue in the alloy particles that are in contact with one another to thereby form the chain particles. The requirement in terms of size needs to be satisfied during the process in which the ferromagnetic alloy forms magnetic domains to cause bonding to one another through magnetic force and, in this bonding state, deposition and growth of the alloy are achieved to cause integration on the whole. Even after alloy particles having a predetermined size or more are bonded through magnetic force, the alloy deposition continues: for example, neck portions at the boundaries between bonded alloy particles grow thicker together with the other portions of the alloy particles.

At this time, deposition that provides the fine protrusions 3k also occurs on the surfaces of the alloy particles. Although the fine protrusions 3k are conspicuous on the projections of the alloy particles 3p, they are also formed on the recesses in connection portions. The cause of the formation of the fine protrusions 3k serving as catalytic specific points lies in the mechanism by which the chain particles 3 are formed (feature (F3) above).

The chain particles 3 contained in an anode 2 preferably have an average diameter D of, for example, 5 nm or more and 500 nm or less; when the chain particles 3 have branches and are intertwined, an average length L thereof is difficult to measure; when the chain particles 3 are not intertwined, the average length L is preferably in the range of 0.5 μm or more and 1000 μm or less. The ratio of the average length L to the average diameter D is preferably 3 or more. Note that the chain particles 3 may have dimensions that do not satisfy these ranges.

The importance of the surface oxidation treatment slightly diminishes for the anode 2 because reduction is to be caused.

Hereinafter, such surface oxidation processes will be described. Three processes are preferred: (i) thermal oxidation by vapor-phase process, (ii) electrolytic oxidation, and (iii) chemical oxidation. In (i), a treatment is preferably performed in the air at 500° C. to 700° C. for 1 to 30 minutes; this is the simplest process; however, control of the thickness of the oxide film is less likely to be achieved. In (ii), the surface oxidation is achieved by anodic oxidation through application of an electric potential of about 3 V with respect to a standard hydrogen electrode; this process has a feature that the thickness of the oxide film can be controlled by changing the amount of electricity in accordance with a surface area; however, for a large area, a uniform oxide film is less likely to be formed. In (iii), the surface oxidation is achieved by immersion for about 1 to about 5 minutes in a solution in which an oxidizing agent such as nitric acid is dissolved; the thickness of the oxide film can be controlled by changing time, temperature, or the type of the oxidizing agent; however, washing the agent off is cumbersome. Although all these processes are preferred, (i) and (iii) are more preferred.

As described above, the oxide layer has a thickness in the range of 1 nm to 100 nm, preferably 10 nm to 50 nm. Note that the thickness may be out of such ranges. When the thickness of the oxide film is excessively small, catalysis is not sufficiently provided; in addition, metalization may be caused even in a slightly reducing atmosphere. On the other hand, when the thickness of the oxide film is excessively large, catalysis is sufficiently maintained; however, electron conductivity is degraded at the interface, resulting in degradation of electric power generation performance.

In the chain particles 3 formed of alloy particles according to the present embodiment, the alloy particles containing Ni, at least one selected from the group consisting of Fe, Co, Cr, W, and Cu, and a trace amount of Ti extend in the form of strings. The features in terms of shape are described in (F1) to (F3) above. Since the chain particles formed of alloy particles are composed of an alloy, they have high catalysis in predetermined alloy composition ranges, compared with chain particles formed of elemental Ni particles. Furthermore, the features (F1) to (F3) above also enhance the catalysis. In particular, a large number of the fine protrusions 3k distributed function as specific points contributing to enhancement of the catalysis. The fine protrusions 3k probably function as sites where bonding between oxygen and an alloy element such as Fe occurs to enhance the catalysis.

In summary, a catalyst that is chain particles formed of alloy particles has higher catalysis promoting the electrochemical reaction for gas decomposition than chain particles formed of elemental Ni particles.

Note that the above-described catalyst relates to the case of chain particles formed of alloy particles and produced by a Ti reduction process. A catalyst according to the present invention is not limited to chain particles formed of alloy particles and produced by a Ti reduction process and may be, for example, a deposit produced by a molten-salt electrodeposition process.

### Second Embodiment—Gas Decomposition Component—

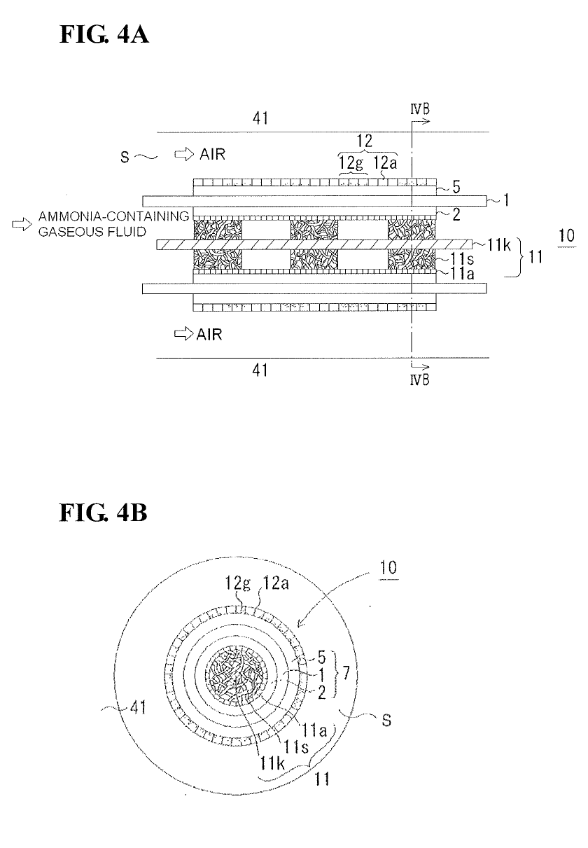

FIG. 4A is a longitudinal sectional view of a gas decomposition component serving as an electrochemical reaction apparatus according to a second embodiment of the present invention, in particular, an ammonia decomposition component 10. FIG. 4B is a sectional view taken along line IVB-IVB in FIG. 4A. In the ammonia decomposition component 10, an anode 2 is disposed so as to cover the inner surface of a cylindrical solid electrolyte 1; a cathode 5 is disposed so as to cover the outer surface of the cylindrical solid electrolyte 1; thus, a cylindrical MEA 7 (1, 2, 5) is formed. The anode 2 may be referred to as a fuel electrode. The cathode 5 may be referred to as an air electrode.

The anode 2 contains the chain particles formed of alloy particles and serving as a catalyst described in the first embodiment. The materials forming the anode 2 will be described in detail below.

Although the cylindrical MEA has an inner diameter of, for example, about 20 mm, the inner diameter is preferably varied in accordance with apparatuses to which the MEA is applied. An anode collector 11 is disposed so as to be in the inner cylinder of the cylindrical MEA 7. A cathode collector 12 is disposed so as to surround the outer surface of the cathode 5.

The collectors will be described below.

<Anode Collector 11>: Metal Woven Fabric 11a/Porous Plated Body 11s/Central Conductive Rod 11k

A metal woven fabric 11a is in contact with the anode 2 disposed on the inner-surface side of the cylindrical MEA 7, to conduct electricity through a porous plated body 11s to a central conductive rod 11k. The porous plated body 11s may be Celmet (registered trademark: Sumitomo Electric Industries, Ltd.), which can be formed so as to have a high porosity, for the purpose of decreasing the pressure loss of an ammonia-containing gaseous fluid described below. The following is important: the anode 2 is formed so as to contain the chain particles 3 formed of alloy particles to sufficiently enhance the ammonia decomposition capability; in addition, on the inner-surface side of the cylindrical MEA, while the overall electric resistance of the collector 11 formed of a plurality of members is made low, the pressure loss in the introduction of a gaseous fluid on the anode side is made low.

<Cathode Collector 12>: Silver-Paste-Coated Wiring 12g+Metal Woven Fabric 12a

A metal woven fabric 12a is in contact with the outer surface of the cylindrical MEA 7 to conduct electricity to the external wiring. Silver-paste-coated wiring 12g contains silver serving as a catalyst for promoting decomposition of oxygen gas into oxygen ions in the cathode 5 and also contributes to a decrease in the electric resistance of the cathode collector 12. The cathode 5 may be formed so as to contain silver. However, the silver-paste-coated wiring 12g having predetermined properties in the cathode collector 12 allows passing of oxygen molecules therethrough and contact of silver particles with the cathode 5. Thus, catalysis similar to that provided by silver particles contained in the cathode 5 is exhibited. In addition, this is less expensive than the case where the cathode 5 is formed so as to contain silver particles.

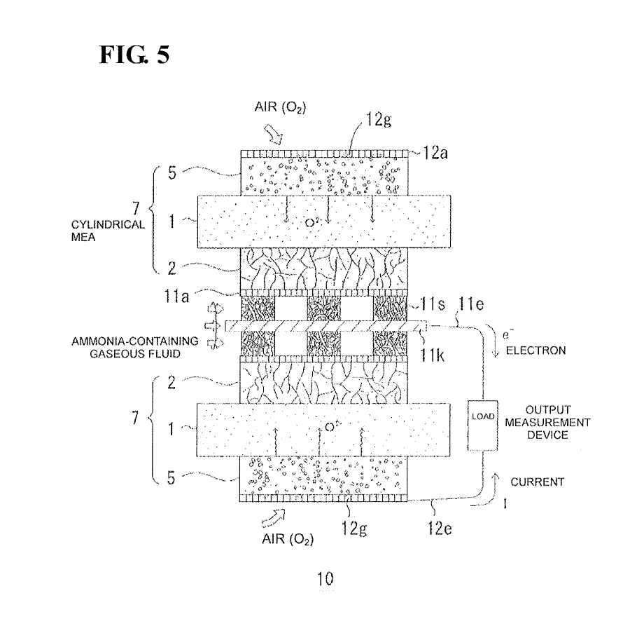

FIG. 5 illustrates the electric wiring system of the gas decomposition component 10 in FIG. 4 when the solid electrolyte is oxygen-ion conductive. An ammonia-containing gaseous fluid is introduced, in a highly airtight manner, into the inner cylinder of the cylindrical MEA 7, that is, the space where the anode collector 12 is disposed. When the cylindrical MEA 7 is used, since the gaseous fluid is passed on the inner-surface side of the cylindrical MEA 7, use of the porous plated body 11s is indispensable. In view of decreasing the pressure loss, as described above, use of a metal-plated body, such as Celmet, is important. While the ammonia-containing gaseous fluid passes through pores in the metal woven fabric 11a and the porous metal 11s, it also comes into contact with the anode 2, resulting in an ammonia decomposition reaction described below. Oxygen ions O²⁻ are generated by an oxygen gas decomposition reaction in the cathode and pass through the solid electrolyte 1 to reach the anode 2. That is, this is an electrochemical reaction in the case where oxygen ions, which are anions, move through the solid electrolyte.

(Anode reaction): 2NH₃+3O²⁻→N₂+3H₂O+6e⁻

Specifically, a portion of ammonia reacts: 2NH₃→N₂+3H₂. These 3H₂ react with the oxygen ions 3O²⁻ to generate 3H₂O. In this decomposition of ammonia, the chain particles 3 formed of alloy particles promote the decomposition. Accordingly, while an outlet concentration described below can be decreased at least to the predetermined level, the ammonia decomposition process can be made at least not to become the bottleneck (process that limits the rate) of the overall electrochemical reaction.

The air, in particular, oxygen gas is passed through a space S and introduced into the cathode 5. Oxygen ions dissociated from oxygen molecules in the cathode 5 are sent to the solid electrolyte 1 toward the anode 2. The cathode reaction is as follows.

(Cathode reaction): O₂+4e⁻→2O²⁻

As a result of the electrochemical reaction, electric power is generated; a potential difference is generated between the anode 2 and the cathode 5; current I flows from the cathode collector 12 to the anode collector 11. When a load, such as a heater 41 for heating the gas decomposition component 10, is connected between the cathode collector 12 and the anode collector 11, electric power for the heater 41 can be supplied. This supply of electric power to the heater 41 may be a partial supply. Rather, in most cases, the amount of supply from the self power generation is equal to or lower than half of the overall electric power required for the heater.

In the first embodiment, the heater was operated with external electric power and an output measurement device was installed as a load in FIG. 5 to measure the output power from the self power generation. The output measurement device is connected to an external wire 11e extending from the central conductive rod 11k of the anode collector 11 and an external wire 12e extending from the metal woven fabric 12a of the cathode collector. As a result of the measurement with the output measurement device, as illustrated in FIG. 2, the composition range where the catalysis is enhanced in the Ni—Fe system was determined.

In the above-described gas decomposition component, the rate at which ammonia is decomposed in the anode 2 is important. When the ammonia decomposition rate in the anode 2 is low, a large portion of ammonia is discharged without being decomposed through the outlet and an outlet concentration of several ppm or less cannot be achieved. To achieve the outlet concentration, when the flow rate of the ammonia-containing gaseous fluid is made low, the treatment performance on the practical level cannot be achieved, which is not allowed. To increase the ammonia decomposition rate in the anode 2, use of the chain particles 3 formed of alloy particles is important.

### <Anode>

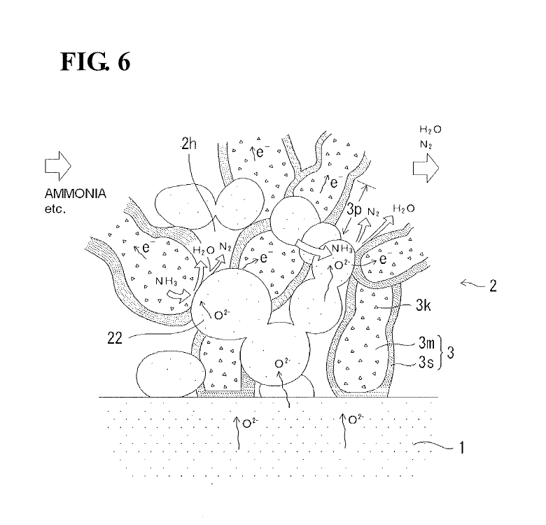

FIG. 6 is an explanatory view of materials and the electrochemical reaction in the anode 2 in the case where the solid electrolyte 1 is oxygen-ion conductive. An ammonia-containing gaseous fluid is introduced into the anode 2 and flows through pores 2h. The anode 2 is a sinter mainly composed of a catalyst, that is, the chain particles 3 formed of alloy particles whose surfaces are oxidized to have oxide layers and an oxygen-ion-conductive ceramic 22. Here, chain particles 3 formed of Ni—Fe system alloy particles are used. As to the composition, for example, the Ni content is about 60 at %.

The composition preferably further contains Ti in a trace amount, about 2 to about 10000 ppm. When a trace amount of Ti is contained, the catalysis can be further enhanced. When such Ni is oxidized to form nickel oxide, the promotion effect due to the elemental metals can be further enhanced. Note that the decomposition reaction of ammonia (anode reaction) is a reduction reaction; in the product to be used, chain particles formed of Ni particles have oxide layers formed by sintering or the like; as a result of use of the product, the chain particles formed of metal particles in the anode are also reduced and the oxide layers are eliminated. However, the Ni—Fe alloy itself certainly has catalysis. In addition, to compensate for the lack of the oxide layers, the Ni—Fe system may contain Ti to compensate for the degradation of the catalysis.

Examples of the oxygen-ion-conductive ceramic 22 include scandium stabilized zirconia (SSZ), yttrium stabilized zirconia (YSZ), samarium stabilized ceria (SDC), lanthanum gallate (LSGM), and gadolia stabilized ceria (GDC).

In addition to the catalysis, in the anode, oxygen ions are used in the decomposition reaction. Specifically, the decomposition is performed in the electrochemical reaction. In the anode reaction 2NH₃+3O²⁻→N₂+3H₂O+6e⁻, oxygen ions contribute to a considerable increase in the decomposition rate of ammonia. (3) In the anode reaction, free electrons e⁻ are generated. When electrons e⁻ remain in the anode 2, the occurrence of the anode reaction is inhibited. The chain particles 3 have the shape of an elongated string; a content 3a covered with an oxide layer 3s is composed of a metal (Ni—Fe alloy) serving as a good conductor. Electrons e⁻ smoothly flow in the longitudinal direction of the string-shaped chain particles. Accordingly, electrons e⁻ do not remain in the anode 2 and pass through the contents 3a of the chain particles 3 to the outside. The chain particles 3 considerably facilitate passage of electrons e⁻. In summary, features in an embodiment of the present invention are the following (e1), (e2), and (e3) in the anode.
(e1) promotion of decomposition reaction by chain particles 3 formed of alloy particles (high catalysis: oxide layers 3s also contribute to enhancement of catalysis)
(e2) promotion of decomposition by oxygen ions (promotion of decomposition in electrochemical reaction)
(e3) establishment of conduction of electrons with string-shaped good conductor 3m of chain particles 3 (high electron conductivity)

These (e1), (e2), and (e3) considerably promote the anode reaction.

By simply increasing the temperature and contacting with the catalyst 3 a gas to be decomposed, decomposition of this gas proceeds. However, as described above, in a component constituting a fuel cell, oxygen ions supplied from the cathode 5 and through the ion-conductive solid electrolyte 1 are used in the reaction and the resultant electrons are conducted to the outside; thus, the rate of the decomposition reaction is considerably increased. A big feature of the present invention is the functions (e1), (e2), and (e3) above and a configuration providing these functions.

In the above description, the case where the solid electrolyte 1 is oxygen-ion conductive is described. Alternatively, the solid electrolyte 1 may be proton (H⁺)-conductive. In this case, the ion-conductive ceramic 22 in the anode 2 is a proton-conductive ceramic, for example, barium zirconate.

When the oxygen-ion-conductive metal oxide (ceramic) in the anode 2 is SSZ, a SSZ raw-material powder has an average particle diameter of about 0.5 μm to about 50 μm. The mixing ratio (mol ratio) of the chain particles 21 formed of metal particles whose surfaces are oxidized to SSZ 22 is in the range of 0.1 to 10. The mixture is sintered by, for example, being held in the air atmosphere at a temperature in the range of 1000° C. to 1600° C. for 30 to 180 minutes. The production method, in particular, the production method of the cylindrical MEA 7 will be described below.

### <Anode Collector 11>

### (i) Metal Woven Fabric 11a of Anode Collector:

The metal woven fabric 11a in the anode collector 11 is an important component that decreases the electric resistance of the anode collector 11, which contributes to a decrease in the pressure loss of the gas flow.

As described above, even when a metal-plated body Celmet (registered trademark) is used as the porous plated body 11s, the absence of a metal woven fabric results in a relatively high contact resistance: the electric resistance between the cathode collector 12 and the anode collector 11 of the gas decomposition component 10 is, for example, about 4 to about 7Ω. By inserting the metal woven fabric 11a into this structure, the electric resistance can be decreased to about 1Ω or less, that is, decreased by a factor of about 4 or more.

From the case where the metal woven fabric 11a is used in the anode collector 11, the following have been revealed.
(N1) By disposing the metal woven fabric 11a, it will suffice that the porous plated body 11s is discontinuously disposed inside the cylindrical MEA. That is, the necessity of continuously arranging the porous plated body 11s over the entire length of the cylindrical MEA 7 is eliminated.
(N2) As a result of discontinuously arranging the porous plated body 11s at intervals, pressure loss in the flow of the ammonia-containing gaseous fluid can be considerably decreased. As a result, for example, a sufficiently large amount of an ammonia-containing gaseous fluid discharged from a waste-gas unit of semiconductor fabrication equipment can be extracted without application of a high negative pressure and the electric-power cost required for extracting the gaseous fluid can be reduced.

In addition, by using a woven fabric of an alloy containing nickel (Ni) and at least one selected from the group consisting of iron (Fe), cobalt (Co), chromium (Cr), tungsten (W), and copper (Cu) or a metal-fiber woven fabric including a plated layer of the alloy, the anode reaction can be promoted (catalysis due to woven fabric 11a).

When the metal woven fabric is disposed between the anode 2 and the porous plated body 11s, anode 2/metal woven fabric 11a/porous plated body 11s can be fixed at the interfaces by reduction bonding. In this case, metal paste is preferably sufficiently applied to the interfaces and near-interface regions to ensure the reduction bonding. By using, as the metal particles, particles having an average particle of 100 μm or less and being formed of an alloy containing nickel (Ni) and at least one selected from the group consisting of iron (Fe), cobalt (Co), chromium (Cr), tungsten (W), and copper (Cu), or particles including a plated layer of the alloy, the anode reaction can be promoted (catalysis due to alloy particles).

### (ii) Porous Plated Body 11s of Anode Collector 11

To ensure conductivity while the pressure loss is made low, the porous plated body 11s of the current-collecting member for the anode 2 is preferably a metal-plated body. The porous plated body 11 is preferably Celmet (registered trademark) described above. The porous plated body 11s can be formed so as to have a high porosity of, for example, 0.6 or more and 0.98 or less; thus, it can function as a component of the collector for the anode 2 serving as an inner-surface-side electrode and can also have very high gas permeability.

When the porosity is less than 0.6, the pressure loss becomes high; when forced circulation employing a pump or the like is performed, the energy efficiency decreases and, for example, bending deformation is caused in ion-conductive members and the like, which is not preferable. To reduce the pressure loss and to suppress damage to ion-conductive members, the porosity is preferably 0.8 or more, more preferably 0.9 or more. On the other hand, when the porosity is more than 0.98, the electric conductivity becomes low and the current-collecting capability is degraded.

There is also a case where the metal woven fabric is not used and the porous plated body 11s is in direct contact with the anode, which is not employed in the present embodiment. In this case, by using a porous plated body formed of an alloy containing nickel (Ni) and at least one selected from the group consisting of iron (Fe), cobalt (Co), chromium (Cr), tungsten (W), and copper (Cu) or a porous plated body including a plated layer of the alloy, the anode reaction can be promoted (catalysis due to porous plated body 11s).

(iii) Central Conductive Rod 11k of Anode Collector 11

When the MEA 7 is cylindrical, the central conductive rod 11k is preferably employed in the anode collector 11.

For example, the central conductive rod 11k composed of nickel is preferably employed. In this case, the following advantages can be provided.
(K1) The overall electric resistance from the anode 2 to the external wiring can be decreased.
(K2) For current collection on the inner-surface side of the cylindrical MEA, a porous plated body is indispensable; it is known that an end portion of the porous plated body is less likely to be converged. However, by using the central conductive rod 11k, a terminal portion having a small size can be formed.
(K3) To efficiently operate the gas decomposition component 10, it needs to be heated to 600° C. to 1000° C. The position where the heater 41 for the heating can be disposed is outside the air passage. When the central conductive rod 11k is used, it is disposed at a position far from the heater-41-side outside and can be easily extended in the axial direction. Accordingly, at an extension position at a relatively low temperature, the electrical connection to the external wiring and the connection to the gaseous-fluid transfer passage can be achieved in a highly airtight manner. As a result, the necessity of using special resins has been eliminated and a resin having heat resistance and corrosion resistance on the ordinary level can be used. Thus, the cost efficiency can be increased and the durability can be enhanced.

### <Cathode>

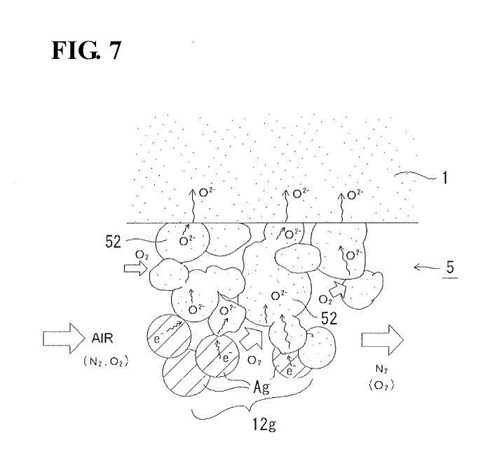

FIG. 7 is an explanatory view of the electrochemical reaction in the cathode 5 in the case where the solid electrolyte 1 is oxygen-ion conductive. In the cathode 5, the air, in particular, oxygen molecules are introduced.

The cathode 5 is a sinter mainly composed of an oxygen-ion-conductive ceramic 52. In this case, preferred examples of the oxygen-ion-conductive ceramic 52 include lanthanum strontium manganite (LSM), lanthanum strontium cobaltite (LSC), and samarium strontium cobaltite (SSC). When the solid electrolyte 1 is oxygen-ion conductive, the cathode 5 may be formed so as not to contain chain particles.

In the cathode 5 according to the present embodiment, Ag particles are disposed in the form of the silver-paste-coated wiring 12g. In this form, the Ag particles exhibit catalysis that considerably promotes the cathode reaction: O₂+4e⁻→2O²⁻. As a result, the cathode reaction can proceed at a very high rate. The Ag particles preferably have an average diameter of 10 nm to 100 nm.

In the above description, the case where the solid electrolyte 1 is oxygen-ion conductive is described. Alternatively, the solid electrolyte 1 may be proton (H⁺)-conductive. In this case, the ion-conductive ceramic 52 in the cathode 5 is a proton-conductive ceramic, for example, preferably barium zirconate. Furthermore, the chain particles 3 serving as a catalyst are preferably used. In particular, the chain particles 3 in which oxide layers 3s are formed by a surface oxidation treatment are preferably used. In this case, although silver particles are preferably used, they may be omitted.

In the cathode 5, SSZ having an average diameter of about 0.5 μm to about 50 μm is preferably used. Sintering conditions are holding in the air atmosphere at a temperature in the range of 1000° C. to 1600° C. for about 30 to about 180 minutes.

### <Cathode Collector>

### (i) Silver-Paste-coated Wiring 12g of Cathode Collector 12:

Conventionally, in general, silver particles are disposed in the cathode 5 so that catalysis by the silver particles is used to increase the decomposition rate of oxygen molecules. However, in the structure including the cathode 5 containing silver particles, the cost of the cathode 5 becomes high, resulting in a decrease in cost efficiency. Instead of forming the cathode 5 so as to contain silver particles, silver-particle wiring can be formed in the form of a silver-paste-coated layer on the outer surface of the cathode 5. The silver-paste-coated wiring 12g may be formed by, for example, applying silver paste onto the outer circumferential surface of the cathode 5 such that band-shaped wires are disposed in a grid pattern (in the generatrix direction and in the circular direction). In the silver paste, it is important that the silver paste is dried or sintered so as to provide a porous structure having a high porosity. By using the silver-paste-coated wiring 12g that is porous, (C1) the cathode reaction can be promoted and (C2) the electric resistance of the cathode collector 12 can be decreased.

### (ii) Metal Woven Fabric 12a:

By using, as the woven fabric 12a of the cathode collector 12, a woven fabric of an alloy containing nickel (Ni) and at least one selected from the group consisting of iron (Fe), cobalt (Co), chromium (Cr), tungsten (W), and copper (Cu) or a metal-fiber woven fabric including a plated layer of the alloy, oxidation resistance can be enhanced to achieve high durability allowing a low electric resistance maintained for a long period of time. The cathode reaction can be promoted, though this depends on the alloy.

Furthermore, by forming a silver-plated layer on a metal woven fabric such as a woven fabric formed of Ni fibers, decomposition of oxygen molecules can be promoted. As a result, oxidation resistance can be enhanced. In addition, because of silver, the electric resistance can be decreased.

### <Solid Electrolyte>

Although the electrolyte 1 may be a solid oxide, molten carbonate, phosphoric acid, a solid polymer, or the like, the solid oxide is preferred because it can be used in a small size and easily handled. Preferred examples of the solid oxide 1 include oxygen-ion-conductive oxides such as SSZ, YSZ, SDC, LSGM, and GDC.

In another desirable embodiment according to the present invention, for example, the solid electrolyte 1 is composed of barium zirconate (BaZrO₃) and a reaction is caused in which protons are generated in the anode 2 and moved through the solid electrolyte 1 to the cathode 5. When a proton-conductive solid electrolyte 1 is used, for example, in the case of decomposing ammonia, ammonia is decomposed in the anode 2 to generate protons, nitrogen molecules, and electrons; the protons are moved through the solid electrolyte 1 to the cathode 5; and, in the cathode 5, the protons react with oxygen to generate water (H₂O). Since protons are smaller than oxygen ions, they move through the solid electrolyte at a higher speed than oxygen ions. Accordingly, while the heating temperature can be decreased, the decomposition capacity on the practical level can be achieved. In addition, the solid electrolyte 1 can be easily formed so as to have a thickness providing a sufficient strength.

For example, when ammonia is decomposed with a cylindrical-body MEA, an anode is disposed inside the cylindrical-body MEA, and an oxygen-ion-conductive solid electrolyte is used, a reaction generating water occurs inside the cylindrical body (in the anode). The water takes the form of water droplets at low-temperature portions near the outlet of the cylindrical-body MEA and may cause pressure loss. In contrast, when a proton-conductive solid electrolyte is used, protons, oxygen molecules, and electrons react in the cathode (outside) to generate water. Since the outside is substantially open, even when water droplets adhere to low-temperature portions near the outlet, pressure loss is less likely to be caused.

### <Method for Producing Cylindrical MEA>

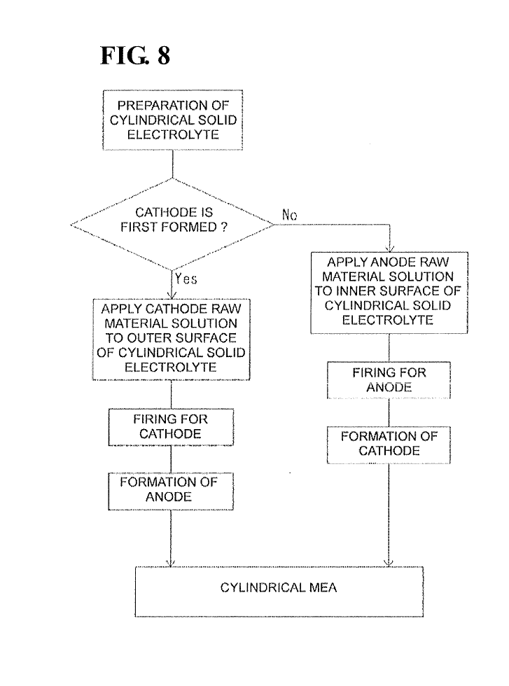

Referring to FIG. 8, an overview of a method for producing the cylindrical MEA 7 will be described. FIG. 8 illustrates steps in which the anode 2 and the cathode 5 are separately sintered. A cylindrical solid electrolyte 1 that is commercially available is first bought and prepared. When the cathode 5 is then formed, a solution is prepared by dissolving a cathode-forming material in a solvent to achieve a predetermined flowability; and the solution is uniformly applied to the outer surface of the cylindrical solid electrolyte. The applied material is then sintered under sintering conditions suitable for the cathode 5 (under slightly mild conditions in view of sintering to be performed under sintering conditions for the anode described below). Subsequently, formation of the anode 2 is performed. In the case of the anode 2, the chain particles 3 formed of alloy particles and the ion-conductive ceramic 22 are dispersed also in a solvent having flowability; and the solution is uniformly applied to the inner surface of the cylindrical solid electrolyte 1. The chain particles 3 formed of alloy particles and the ion-conductive ceramic 22 are then sintered under sintering conditions suitable for the anode 2.

Other than the production methods illustrated in FIG. 8, there are a large number of variations. In a case in which sintering is performed only once, the sintering is not performed separately for the portions as illustrated in FIG. 8, but the portions are formed in the applied state and finally the portions are sintered under conditions suitable for both of the portions. In addition, there are a large number of variations. The production conditions can be determined in comprehensive consideration of, for example, materials forming the portions, a target decomposition efficiency, and production costs.

The above-described production method relates to the case where chain particles formed of alloy particles and formed by a Ti reduction process are used. Alternatively, in the case of the anode 2, the ion-conductive ceramic 22 and the alloy deposit may be directly deposited on the solid electrolyte 1 by a molten-salt electrodeposition process.

The gas decomposition component 10 described herein has the cylindrical MEA 7 and a gas to be detoxified is passed through the cylinder. However, in a gas decomposition component according to the present invention, the MEA is not limited to a cylindrical shape and may have any shape. For example, a plate-shaped multilayer body in which a plurality of plate-shaped MEAs are laminated with a porous metal body (porous plated body) therebetween may be employed.

### Third Embodiment

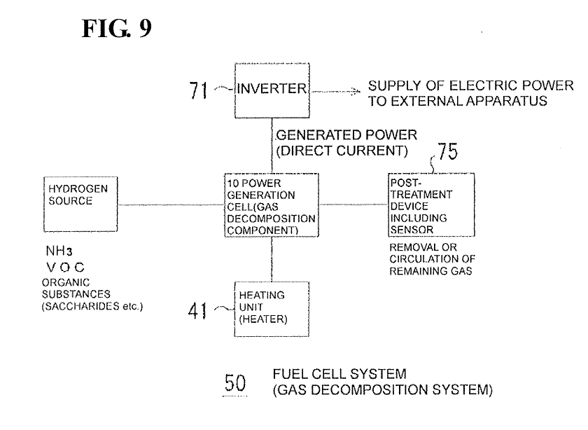

FIG. 9 illustrates a gas decomposition system functioning as a fuel cell in a third embodiment of the present invention. In this fuel cell system 50, a hydrogen source that is hydrogen-containing molecules such as ammonia, toluene, and xylene is supplied from a hydrogen source and decomposed in a power generation cell 10 or a gas decomposition component 10. As described above, the gas decomposition component 10 may have any shape. A single gas decomposition component may be disposed or a plurality of gas decomposition components may be arranged. An anode (not shown) of the gas decomposition component 10 contains the chain particles 3 formed of alloy particles which is described in the first and second embodiments. The electrochemical reaction of gas decomposition results in generation of electric power. A portion of the electric power is used for a heating unit (heater) 41 for enhancing the gas decomposition performance or power generation performance. The remainder of the electric power is converted to an electric-power form compatible with an external apparatus, for example, by alternating-current/direct-current conversion with an inverter 71 and boosting of the voltage. Thus, the fuel cell system of the present embodiment can employ various hydrogen sources including organic substances such as saccharides and can be used as a power supply for electronic devices such as personal computers (PCs) and mobile terminals or a power supply for electric devices consuming higher electric power.

A gaseous fluid discharged from the power generation cell 10 or the gas decomposition component 10 after decomposition is measured with a post-treatment device (including sensor) 75 in terms of concentrations of remaining components and treated to ensure safety. In this case, depending on the concentrations of remaining components, the gaseous fluid can be returned for circulation.

In the fuel cell system 50, making the concentration of the gas component be very low as in the case for gas detoxification is not necessary; by causing the electrochemical reaction for decomposition at a high gas-component concentration, high power-generation performance can be achieved.

### (Another Gas Decomposition Component)

Table I describes examples of other gas decomposition reactions to which a catalyst and an electrode according to the present invention can be applied.

A gas decomposition reaction R1 is an ammonia/oxygen decomposition reaction described in the second embodiment. In addition, a catalyst and an electrode according to the present invention can be applied to all the gas decomposition reactions R2 to R20: specifically, ammonia/water, ammonia/NOx, hydrogen/oxygen/, ammonia/carbon dioxide, volatile organic compounds (VOC)/oxygen, VOC/NOx, water/NOx, and the like.

TABLE I

| | Item | | | | |
|---|---|---|---|---|---|
| | Gas introduced | Moving | Gas introduced | | Electrochemical |
| Number | into anode | ion | into cathode | Mode | reaction |
| R1 | NH₃ | O²⁻ | O₂ | Power generation | Oxidation |
| R2 | NH₃ | O²⁻ | H₂O | Power generation | Oxidation |
| R3 | NH₃ | O²⁻ | NO₂, NO | Power generation | Oxidation |
| R4 | H₂ | O²⁻ | O₂ | Power generation | Oxidation |
| R5 | NH₃ | O²⁻ | CO₂ | Electrolysis | Oxidation |
| | | | | (supply of electric power) | |
| R6 | VOC such as CH₄ | O²⁻ | O₂ | Power generation | Oxidation |
| R7 | VOC such as CH₄ | O²⁻ | NO₂, NO | Electrolysis | Oxidation |
| | | | | (supply of electric power) | |
| R8 | H₂O | O²⁻ | NO₂, NO | Electrolysis | Oxidation |
| | | | | (supply of electric power) | |
| R20 | Cyan-based hydrogen | O²⁻ | O₂ | Low power generation | Oxidation |
| | such as HCN | | | | |

Table I merely describes several examples of a large number of electrochemical reactions. A catalyst and an electrode according to the present invention are also applicable to a large number of other reactions. For example, the reaction examples in Table I are limited to examples in which oxygen-ion-conductive solid electrolytes are employed. However, as described above, reaction examples in which proton (H⁺)-conductive solid electrolytes are employed are also major embodiments of the present invention. Even when a proton-conductive solid electrolyte is employed, in the combinations of gases described in Table I, the gas molecules can be finally decomposed, though the ion species passing through the solid electrolyte is proton. For example, in the reaction (R1), in the case of a proton-conductive solid electrolyte, ammonia (NH₃) is decomposed in the anode into nitrogen molecules, protons, and electrons; the protons move through the solid electrolyte to the cathode; the electrons move through the external circuit to the cathode; and, in the cathode, oxygen molecules, the electrons, and the protons generate water molecules. In view of the respect that ammonia is finally combined with oxygen molecules and decomposed, this case is the same as the case where an oxygen-ion solid electrolyte is employed.

The above-described electrochemical reactions are gas decomposition reactions intended for gas detoxification. There are also gas decomposition components whose main purpose is not gas detoxification. A gas decomposition component according to the present invention is also applicable to such electrochemical reaction apparatuses, such as fuel cells.

Embodiments of the present invention have been described so far. However, embodiments of the present invention disclosed above are given by way of illustration, and the scope of the present invention is not limited to these embodiments. The scope of the present invention is indicated by Claims and embraces all the modifications within the meaning and range of equivalency of the Claims.

### INDUSTRIAL APPLICABILITY

For example, a catalyst and an electrode according to the present invention allow high treatment performance in small electrochemical reaction apparatuses and can provide small fuel cells, small gas detoxification apparatuses, and the like. The small fuel cells are useful for mobile terminals, PCs, and the like. The small gas detoxification apparatuses are easily installed in positions immediately after the discharge part of fabrication equipment; even when exhaust pipes are damaged by an earthquake or the like, the exhaust has passed through the detoxification apparatuses and the gas has been substantially decomposed to a low concentration; thus, serious accidents are not caused.

### REFERENCE SIGNS LIST

1 solid electrolyte

2 anode

2h pore in anode

3 alloy chain particle (catalyst)

3b branch portion

3k fine protrusion

3m alloy portion (inside of oxide layer)

3p alloy particle

5 cathode

10 gas decomposition component

11 anode collector

11a metal woven fabric

11e anode external wire

11g Ni paste layer

11k central conductive rod

11s porous plated body (metal-plated body)

12 cathode collector

12a metal woven fabric

12e cathode external wire

12g silver-paste-coated wiring

22 ion-conductive ceramic in anode

71 inverter

75 post-treatment device

S air space

1. A catalyst used for promoting an electrochemical reaction, comprising:
an alloy containing nickel (Ni) and at least one selected from the group consisting of iron (Fe), cobalt (Co), chromium (Cr), tungsten (W), and copper (Cu).

2. The catalyst according to claim 1, being chain particles in which particles that have a diameter of 0.5 μm or less and are formed of the alloy are connected to form an elongated shape.

3. The catalyst according to claim 2, wherein the chain particles have branches and form dendritic chain particles in which the branched chain particles are intertwined.

4. The catalyst according to claim 1, wherein the alloy contains 0.5% or less by weight of titanium (Ti).

5. The catalyst according to claim 1, being a woven fabric formed of fibers of the alloy or a metal-fiber woven fabric including a plated layer of the alloy.

6. The catalyst according to claim 1, being a porous plated body formed of the alloy or a porous plated body including a plated layer of the alloy.

7. The catalyst according to claim 1, being particles that are formed of the alloy and have an average diameter of 100 μm or less.

8. The catalyst according to claim 1, being present with a solid electrolyte and disposed in a form of a film of the alloy or a deposit of the alloy so as to cover a surface of the solid electrolyte.

9. The catalyst according to claim 1, wherein oxygen is bonded to a surface of the alloy or the alloy is covered with an oxide layer.

10. An electrode formed by sintering the catalyst according to claim 1 and an ion-conductive ceramic.

11. The electrode according to claim 10, wherein silver particles are dispersed.

12. A fuel cell comprising the catalyst according to claim 1 or the electrode according to claim 10.

13. A gas detoxification apparatus comprising the catalyst according to claim 1 or the electrode according to claim 10.

14. A method for producing a catalyst, comprising:
a step of preparing an aqueous solution containing a nickel ion, a titanium ion, a complex ion, and at least one type selected from the group consisting of an iron ion, a cobalt ion, a chromium ion, a tungsten ion, and a copper ion; and
a step of adding an alkaline aqueous solution to the aqueous solution and stirring the solutions at room temperature to 60° C. to deposit chain particles formed of an alloy particles containing nickel (Ni), at least one selected from the group consisting of iron (Fe), cobalt (Co), chromium (Cr), tungsten (W), and copper (Cu), and a trace amount of titanium (Ti).

15. The method for producing a catalyst according to claim 14, comprising a step of subjecting the chain particles to a surface oxidation treatment.

16. A method for producing an electrode, comprising, after the method for producing a catalyst according to claim 14, dispersing the catalyst and a powder of an ion-conductive ceramic in a solvent having flowability, applying the solvent containing the catalyst and the ion-conductive ceramic to a solid electrolyte, and sintering the catalyst and the ion-conductive ceramic.
